(19) United States
(12) Patent Application Publication
(10) Pub. No.: US 2026/0110253 A1
(43) Pub. Date: Apr. 23, 2026

(54) SEALING ASSEMBLY FOR A TURBOMACHINE

(71) Applicant: SAFRAN AIRCRAFT ENGINES, Paris (FR)

(72) Inventors: Jérôme Claude George LEMONNIER, Moissy-Cramayel (FR); Franck Davy BOISNAULT, Moissy-Cramayel (FR); Fabrice Marcel Noël GARIN, Moissy-Cramayel (FR); Damien BONNEAU, Moissy-Cramayel (FR); Florian Armand Gabriel GAUDRY, Moissy-Cramayel (FR); Jean-Marc Michel LESAINE, Moissy-Cramayel (FR)

(73) Assignee: SAFRAN AIRCRAFT ENGINES, Paris (FR)

(21) Appl. No.: 19/168,067

(22) PCT Filed: Mar. 20, 2024
(86) PCT No.: PCT/FR2024/050330

§ 371 Date: Sep. 23, 2025

(30) Foreign Application Priority Data
Mar. 23, 2023 (FR) FR2302762

(51) Int. Cl. F01D 11/02

(52) U.S. Cl. CPC F01D 11/025; F05D 2240/12; F05D 2240/55

(57) ABSTRACT

A sealing assembly for a turbomachine including a sealing gasket configured to ensure a predefined clearance between the sealing gasket and an external surface of a rotor mounted in rotation around an axis A, the axis A defining an axial direction, the sealing gasket extending circumferentially around the axis A and the external surface being arranged facing the sealing gasket, the sealing assembly being characterized in that it further includes an air straightening member including at least one row of blades which extend radially, the air straightening member being located upstream of the sealing gasket, the air straightening member being configured to straighten the air intended to pass through the sealing gasket.

### TECHNICAL FIELD

The present disclosure relates to sealing assemblies for aeronautical turbomachines.

### PRIOR ART

The design of ventilation circuits of an aeronautical turbomachine is delicate and represents a potential loss of performance.

In fact, the turbomachine is all the more efficient when it operates at high temperature. However, the materials constituting it then necessitate greater cooling. Cooling is generally accomplished by extracting a portion of the air from the cold-air stream, which harms the overall performance.

Further, the cooling circuit imposes implementing a complex architecture to allow the cooling air to reach the blades to be cooled from the place where it is extracted.

In order to ensure that the air circuit is not fed by more cooling air than necessary, and therefore does not unduly harm the performance of the turbomachine, labyrinth seals are generally arranged at the air extraction points.

Such sealing gaskets allow ensuring a controlled air passage at the places where they are arranged. The conventional architecture of labyrinth seals comprises rubbing seals arranged facing abradable elements which have a cellular structure of the honeycomb type.

Nevertheless, this type of sealing gasket has as a disadvantage that the wear of the rubbing seals by friction against the abradable element increases the clearance of the sealing gasket at the scale of the lifetime of the gasket, and thus allows greater air passage, which ultimately leads to too great an extraction of air and therefor to a loss of performance of the turbomachine.

Alternatives are sometimes proposed for such labyrinth type sealing gaskets.

For example, self-adjusting sealing gaskets are proposed, sometimes called hydrostatic in the literature.

Such sealing gaskets propose to form a sealing gasket by arranging a main surface of the gasket which comprises patterns facing another surface, in rotation relative to the main surface and separated from it by a predefined clearance.

It is understood that the sealing implemented here is not strict sealing where the air could not pass through the gasket, but rather relative sealing, the purpose of the sealing gasket being to let a defined quantity of air pass, quantified by the predefined clearance.

The sealing gasket is said to be self-adjusting because the surface comprising patterns interacts with the incident air flow in such a manner that:
if the clearance decreases, the pressure of the air between the surface of the gasket and the facing surface increases, so as to drive the sealing gasket away and thus return it to the predefined clearance; and
if the clearance increases, the pressure of the air between the sealing gasket and the facing surface decreases, so that a return element connected to the gasket allows returning the sealing gasket to the predefined clearance.

It must however be noted that the use of such sealing gaskets is currently limited by the fact that the contact between the main surface of the sealing gasket and the facing surface must be avoided under any circumstance, and in particular even during unusual, limit or accidental behavior.

The proper operation of these sealing gaskets is intimately linked to the pressure conditions upstream and downstream of the sealing gasket, which generate a force below the self-adjusting sealing gasket.

In the conventional architecture of turbomachines, these pressure conditions are imposed by the operating conditions of the turbomachine and cannot in any case be adjusted to favor the operation of these sealing gaskets.

There remains therefor a need to improve the operation of these sealing gaskets without having to modify the operating conditions of the turbomachine.

### Disclosure of the Invention

The invention seeks precisely to respond to this need.

The invention thus relates, according to a first of its aspects, to a sealing assembly for a turbomachine comprising a sealing gasket configured to ensure a predefined clearance between said sealing gasket and an external surface of a rotor mounted in rotation around an axis A, the axis A defining an axial direction, the sealing gasket extending circumferentially around the axis A and the external surface being arranged facing the sealing gasket,
the sealing assembly being characterized in that it further comprises an air straightening member comprising at least one row of blades which extend radially, the air straightening member being located upstream of the sealing gasket, the air straightening member being configured to straighten the air intended to pass through the sealing gasket.

In other words, the straightening member allows cancelling the tangential component of the air reaching the sealing gasket.

It is in fact praiseworthy of the inventors to have understood and documented that the tangential speed of the air reaching the sealing gasket plays an important role in the operation of the gasket.

The tangential speed of the air reaching the sealing gasket is explained by the fact that it is in contact with parts moving in rotation in the turbomachine. It is usually considered beneficial for sealing gaskets because it allows their equilibrium clearance to be reduced.

However, the inventors have observed that at the cost of a slight increase in equilibrium clearance, straightening the incident air, i.e. depriving it of its tangential speed component, allows reducing by at least 20% the pressure ratio between upstream and downstream of the gasket necessary for the joint to set itself in motion and return to equilibrium.

The loss due to the increase of equilibrium clearance is thus largely compensated by the assurance that the gasket returns more rapidly to its equilibrium clearance at all the engine speeds of the turbomachine.

In one embodiment, the axis A can be the main axis of a turbomachine.

Such an assembly allows more particularly benefitting from the advantages described above, and in particular having a sealing gasket in which the pressure ratio between upstream and downstream of the sealing gasket necessary for returning the sealing gasket to its equilibrium position is greatly reduced, compared to a sealing gasket not comprising an air straightening member.

In one embodiment, the sealing gasket is a gasket having a return mechanism based on a pressure differential between upstream and downstream of the gasket.

It is understood that the sealing implemented here is not strict sealing in the sense that the air could not pass the sealing assembly, but rather relative sealing, the purpose of the sealing gasket being to allow a defined quantity of air to pass.

The air that can cross the sealing assembly allows for example preventing the appearance of pumping phenomena, or even extracting a portion of the air necessary for cooling, for example for the cooling of hot parts.

As described, the blades of the air straightening member extend radially, i.e. their leading edges and their trailing edges extend in the radial direction.

As described, these blades, and more generally the air straightening member, are configured to straighten the air intended to pass through the sealing gasket. What is meant by that is that the profile of the blades, i.e. their extent in the two other dimensions of space, are selected so that the incident air having a non-zero tangential speed component passing through the air straightening member leaves it with a reduced tangential speed component.

In one embodiment, the air straightening member comprises from 10 to 40 fixed blades (including terminals), the profile of which is defined in such a manner that it allows the cancelling of the tangential component of the air reaching the sealing gasket.

This embodiment allows ensuring straightening of the air which reduces by at least 20% the ratio between the pressure upstream and downstream of the gasket necessary to return the gasket to its equilibrium clearance, compared with a sealing gasket alone.

In one embodiment, the distance between the inlet of the air straightening member and the upstream edge of the sealing gasket can be comprised between 10 mm and 20 mm.

This embodiment allows, on the one hand, for the straightening of the air to occur while ensuring a laminar flow, and on the other hand, by maximally reducing the dimensions of the straightening member, minimizes its weight.

The inlet of the air straightening member considered here is the first element of the air straightening member reached by the incident air. In one embodiment, the inlet of the air straightening member can be the leading edge of the blades of the air straightening member.

In one embodiment, the distance between the exit of the air straightening member and the upstream edge of the sealing gasket can be comprised between 2.0 mm and 5.0 mm.

This embodiment allows obtaining limited axial bulk of the assembly of the invention.

The exit of the straightening member considered here is the last element of the straightening member passed through by the incident air. In one embodiment, the exit of the straightening member can be the trailing edge of the blades of the air straightening member.

In one embodiment, the air straightening member can comprise a spacer which allows calibrating the gap between the air straightening member and the sealing gasket.

In one embodiment, the spacer is a calibrated excrescence arranged in the axial direction.

In one embodiment, the air straightening member comprises a spacer integral with the air straightening member.

In one embodiment, the sealing assembly described above is arranged radially between the external surface of a rotor mounted in rotation around the axis A and a fixed portion of a turbomachine casing.

In one embodiment, the fixed portion of a turbomachine casing comprises a radial recess.

Such a radial recess allows facilitated arrangement of the sealing gasket, the latter being able to be simply arranged abutting against the radial recess of the casing.

In one embodiment, the sealing assembly can be arranged radially between a fixed portion of a turbomachine casing and the external surface of the rotor mounted in rotation around the axis A, and in which the sealing gasket is arranged axially between a radial recess of the fixed portion of the turbomachine casing and the spacer of the air straightening member.

This embodiment ensures simplified placement of the sealing assembly.

In one embodiment, the air straightening device can comprise a spacer which allows axial separation between the exit of the air straightening device and the sealing gasket.

In such an embodiment, the spacer preferably has an axial length equal to the desired length between the downstream of the air straightening member and the inlet of the sealing gasket.

This allows easier arrangement of the air straightening member, because the latter can then be arranged by abutting the spacer against the sealing gasket.

In one embodiment, the sealing gasket can be arranged axially between a spacer of an air straightening member described above, and a radial recess made in the fixed portion of the casing.

In an identical or different embodiment, the air straightening device can comprise a radially external attachment flange which is mounted against a radial external flange of the fixed portion of the turbomachine casing.

Such an embodiment allows easy arrangement of the air straightening member in a turbomachine, its arrangement relative to the fixed portion of the casing being accomplished by abutting the radially external attachment flange of the air straightening member against the radially external attachment flange of the fixed portion of the casing.

In one embodiment, the sealing assembly can be arranged radially between a fixed portion of a turbomachine casing and an external surface of the rotor mounted in rotation around the axis A and in which the air straightening member comprises a radially external attachment flange which is mounted against an external radial flange of the fixed portion of the turbomachine casing.

This embodiment ensures simplified placement of the sealing assembly.

In one embodiment, the distance between the radially interior end of the air straightening member and the external surface of the rotor mounted in rotation around the axis A can be greater than or equal to 2.0 mm.

For example the distance between the radially interior end of the blades of the sealing member and the external surface of the rotor mounted in rotation around the axis A is greater than the predefined clearance of the sealing gasket.

This embodiment ensures that the thermo-mechanical dilations of the external surface of the rotor or its local non-axisymmetric movements are insufficient for the external surface of the rotor to enter into contact with the air straightening member.

In one embodiment, the predefined clearance of the sealing gasket can be comprised between 0.5 mm and 1.0 mm.

This clearance is sufficiently small for limiting the losses of efficiency of the turbomachine while nevertheless ensuring that the operation of the cooling circuit is ensured. This clearance is further sufficiently large for ensuring that the external surface of the rotor does not enter into contact with the gasket in any of the flight regimes.

In one embodiment, the blades of an air straightening member can have a mean line comprised between 15 mm and 25 mm.

The mean line means here, and in the rest of the present description, the curvilinear length of the blade at mid-thickness in a projection perpendicular to the height of the blade, i.e. the extension of the latter in the radial direction.

In one embodiment, the thickness of the blade can be less than or equal to 5.0 mm at all points.

The thickness of the blade means here its dimension perpendicular to its height.

Equivalently, the thickness of the blade is defined at a point of the blade as the shortest trajectory allowing passing from the pressure side to the suction side.

In one embodiment, the thickness of the blade can vary, preferably decrease, when the blade is traversed from upstream to downstream, i.e. from the leading edge to the trailing edge.

Such a reduction in the thickness of the blades allows increasing the passage cross section for the air, and consequently reducing its speed, hence increasing its static pressure.

In one embodiment, all the blades of the air straightening member are identical.

In one embodiment, the ratio between the extent of the blades in the axial dimension and the mean line of the blades is comprised between 0.6 and 0.9.

In one embodiment, the air straightening member comprises a plurality of fixed blades the exit angle of which is less than 10°, perhaps comprised between 0° and 2°.

The exit angle of a blade can be defined as the angle formed by the tangent to the mean line, taken at the trailing edge, and the axis A of the turbomachine.

Such an exit angle allows reducing, even cancelling the tangential component of the speed of the incident air reaching the sealing gasket.

In one embodiment, the gap between two circumferentially adjacent blades of the air straightening member can be comprised less than 40°, for example comprised between 9° and 36°.

The gap between two blades is measured as the angle formed between two circumferentially adjacent blades measured in a plane perpendicular to the direction A.

The smaller the gap between two blades, the better the reduction of the tangential speed of the air passing through the air straightening member.

In one embodiment, the angle of attack of the blades of the air straightening member can be comprised between 30° and 75°.

The angle of attack characterizes the angle formed between the tangent to the mean line of the blade at the leading edge and the direction of the axis A.

An angle of attack conforming to that proposed is optimized for the tangential speed components expected for air leaving a high-pressure compressor and thus allows maximizing the conversion of the tangential component of the speed of the air flow into axial component, while minimizing head losses.

In one embodiment, the air straightening member can be integral with the same wall of the engine as the movable portion of the sealing gasket.

In one embodiment, the sealing gasket can comprise a plurality of gasket sectors distributed circumferentially around the axis A, each gasket sector comprising an internal annular sector connected to an external annular sector by a return member, the sealing gasket being characterized in that the internal surface of each interior gasket sector comprises at least one row of patterns recessed into the internal surface of the internal annular sectors, each of the patterns having a slender shape extending in an oblique direction relative to the axial direction and being separated from another pattern by a non-recessed portion of the internal surface.

Such an architecture of the gasket differs radically from a labyrinth seal and ensures self-adjusting behavior of the sealing gasket.

The “circumferential distribution” of sealing gasket sectors means that each sealing gasket sector defines a portion of the circumference of the gasket, and that the set of sealing gasket sectors allows obtaining the complete sealing gasket.

It is understood that the predefined clearance is a “target” clearance, and that it is possible that the clearance varies slightly about the predefined clearance value under the operating conditions of the sealing gasket. When the sealing gasket is in its equilibrium position, the predefined clearance allows ensuring that the air flow passing through the gasket is the desired air flow. However, if the clearance increases or decreases, the entire sealing gasket will be brought back to the predefined clearance by the spring behavior of the internal annular sectors of the sealing gasket.

According to another of its aspects, the invention relates to an aeronautical turbomachine comprising at least one sealing assembly as described above.

In one embodiment, in such an aeronautical turbomachine the at least one sealing assembly can be arranged on the cooling-air routing circuit, said cooling-air routing circuit comprising an inlet extracting air downstream of the last disk of the high-pressure compressor and an inlet extracting air radially below the combustion chamber in the form of an air orifice leading into an air inlet cavity in communication with the interior cooling circuit and selected from:
the first sealing assembly downstream of the high-pressure compressor traversed by the air extracted downstream of the last disk of the high-pressure compressor;
the upstream interior sealing assembly defining the inlet of said air intake cavity and arranged radially below the air intake orifice;
the upstream exterior sealing assembly defining the exit of said air intake cavity and arranged radially below the high-pressure guide nozzle.

In fact, such sealing assemblies are usually labyrinth sealing gaskets and their replacement by a sealing gasket according to the invention allows obtaining sealing assemblies with increased lifespan, without concession of their performance.

### BRIEF DESCRIPTION OF THE DRAWINGS

FIG. 1 shows a double flow turbojet schematically.

FIG. 2 shows schematically a cooling path in a turbomachine.

FIG. 3 shows schematically a sealing assembly of a particular embodiment seen in a plane perpendicular to the circumferential direction.

FIG. 4 shows schematically a sealing assembly of a particular embodiment in a view different from that of FIG. 3.

FIG. 5 shows schematically a sealing assembly of a particular embodiment seen in a plane perpendicular to the radial direction.

### DESCRIPTION OF THE EMBODIMENTS

The invention is now described by means of figures, presented for the purpose of description to illustrate certain embodiments of the invention which must not be interpreted as limiting the latter.

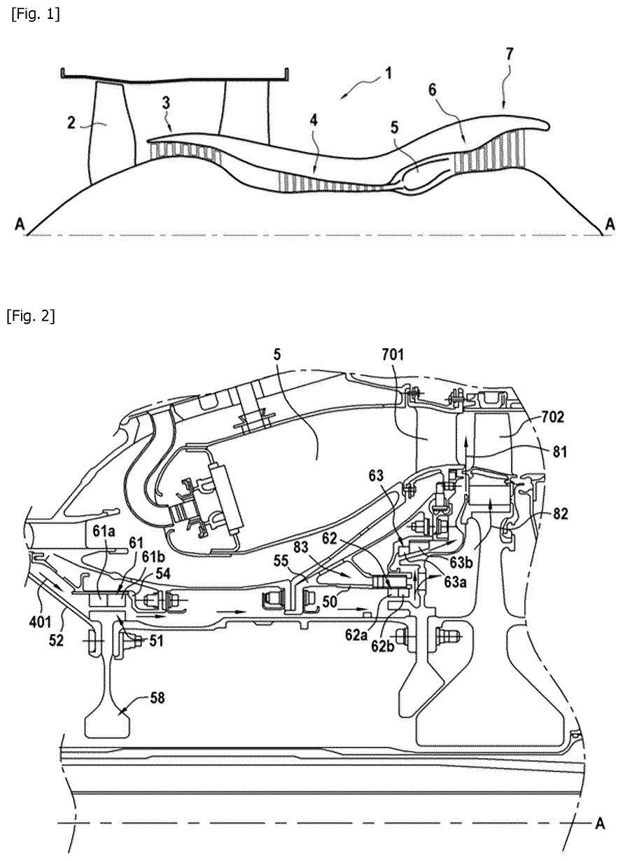

FIG. 1 shows, in section along a vertical plane passing through its main axis A, a double flow turbojet 1. It includes, from upstream to downstream along the air circulation, a fan 2, a low-pressure compressor 3, a high-pressure compressor 4, a combustion chamber 5, a high-pressure turbine 6, and a low-pressure turbine 7.

In the present application, the relative positioning terms, for example “upstream,” “downstream,” “internal” and “external” are understood relative to the horizontal axis A of the casing defining the axial direction, traversed in the direction of the main and secondary air flows of the turbomachine.

Thus an element designated “upstream” will be traversed before an element designated “downstream” and an element designated “internal” will be closer to the axis A than an “external” element.

FIG. 2 shows a portion of the turbomachine visible in FIG. 1, and illustrates that the latter can be provided with sealing gaskets conforming to those described above.

In the embodiment shown, the turbomachine portion has three sealing assemblies: an upstream interior sealing assembly 62 (“FIS”), an upstream exterior sealing assembly 63 (“FOS”) and a sealing assembly downstream of the high-pressure compressor 61 (“CDP”).

Such sealing assemblies are now described in connection with FIG. 2, which is only one example of a configuration for an air cooling path in a turbomachine. A person skilled in the art will be able to identify an upstream exterior sealing assembly 63 (“FOS”), an upstream interior sealing assembly 62 (“FIS”) and a sealing assembly downstream of a high-pressure compressor 61 (“CDP”) in other geometries of the cooling circuit.

In one embodiment shown in FIG. 2, air is extracted downstream of the last compressor disk 401 as well as radially below the combustion chamber 5.

The air extracted downstream of the last compressor disk 401 first traverses the sealing assembly 61, which is located radially below the inlet of the combustion chamber 5.

The sealing assembly comprises a straightening member 61a and a sealing gasket 61b, conforming to what has been described above.

The sealing gasket 61b defines the quantity of air for the cooling circuit 401 extracted downstream of the last disk of the high-pressure compressor 4 and further allows avoiding the appearance of pumping phenomena.

The air 83 extracted radially below the combustion chamber 5 can for example be extracted by an air orifice 50, leading into a cavity comprised between the upstream exterior sealing assembly 63 and the upstream interior sealing assembly 62.

In FIG. 2, these two sealing assemblies bound respectively the inlet and the exit of such a cavity.

The sealing assembly 62 is traversed by the air extracted downstream of the last compressor disk 401 desiring to enter into this cavity, independently of whether it then serves for the cooling circuit 82 or whether it is intended for the bleeding circuit 81.

The sealing assembly 63 bounds the exit of the air intake cavity, and limits the air flow joining the bleeding circuit 81.

For example, the sealing assembly 62 can be located radially below the air intake orifice, while the sealing assembly 63 can be located radially below the first guide nozzle of the high-pressure turbine 701.

In FIG. 2, the bleeding circuit 81 leads between the high-pressure guide nozzle 701 and the high-pressure rotor 702.

In the embodiment shown, it will be noted that the surface facing the sealing gaskets 62b and 63b is an external surface of a stage of the rotor of the high-pressure turbine.

FIG. 2 shows a turbomachine for which the three particular sealing assemblies 61, 62, 63 are described above, but it doesn't depart from the scope of the invention if only one of these sealing assemblies conforms to what is described above.

Hereafter, the sealing assembly 61 will be described, but it is appropriate to note that what is described for this assembly can also be applied to other sealing assemblies.

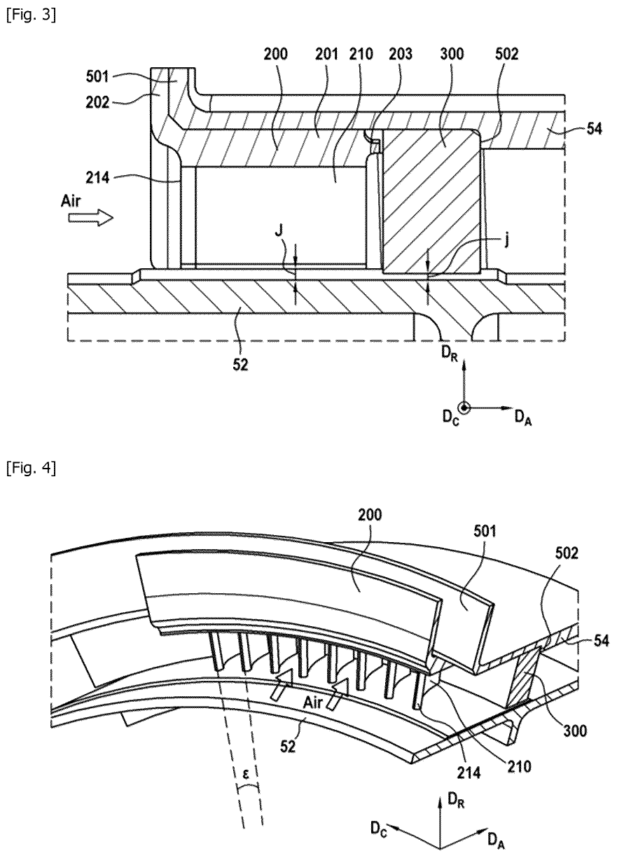

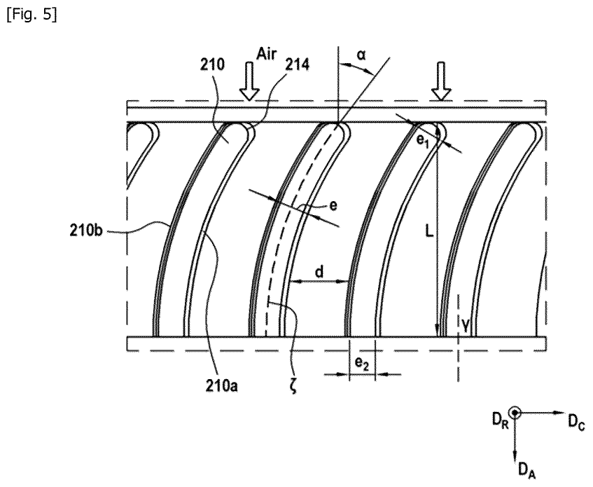

FIGS. 3 and 4 show in two different views a sealing assembly as described.

FIG. 3 shows a view in a plane perpendicular to the circumferential direction, while FIG. 4 shows a point according to another perspective point.

In the present application, it is understood that the axial direction D_{A} is understood the be the direction of the main axis A of the turbomachine; the circumferential direction D_{C} is that forming a circle around the axial direction D_{A}; and the radial direction D_{R} defines a radius of the circle formed by the circumferential direction D_{C} and having as its center the axial direction D_{A}.

These directions appear in FIGS. 3 and 4.

FIG. 3 shows the mutual arrangement of the straightening member 200 of the sealing gasket 300 of a sealing member 61, 62, 63.

The straightening member 200 comprises, in the embodiment shown, a plurality of blades 210 having a particular profile.

The profile of these blades, in the embodiment shown, will moreover be described hereafter in connection with FIG. 5.

FIG. 3 illustrates that the sealing assembly is comprised between a fixed portion 54 of the casing of the turbomachine, for example integral with the combustion chamber 5, and a movable portion 52.

The movable portion 52 can be a turbomachine rotor shroud.

Alternatively, and as shown in FIG. 2, the movable portion can be a surface 51 of a shroud direction connected to a riser 58.

Alternatively, for example if the sealing assembly occupies a different position in the cooling circuit, the fixed portion can be a portion 55 integral with the combustion chamber 5 and arranged radially below the latter.

The sealing gasket 300 of FIGS. 3 and 4 is shown schematically. It is seen, however, that the latter defines an opening clearance j between the interior portion of the gasket and the movable surface 52 facing the latter.

In the embodiment shown, the sealing assembly further comprises a spacer 203. The latter is integral with the straightening member 200.

This embodiment ensures simplified mounting of the sealing assembly, because it is sufficient to place the gasket 300 in contact with the spacer 203 to ensure that the straightening member 200, integral with the spacer 203, is then at the desired distance from the gasket 300.

In the embodiment shown, the blades of the straightening member have a leading edge 214 which has a particular orientation with respect to the entering air flow.

Preferably, the angle of attack α, i.e. the orientation formed by the leading edge of the blade, is selected depending on the expected tangential speed of the incident air flow so that the straightening member works at its best in eliminating the tangential component.

In the embodiment of FIG. 3, it is also possible to observed the clearance J between the radially interior end of the blades 210 of the straightening member 200 and the surface of the rotor mounted in rotation around the axis A.

Preferably, the clearance J is greater, for example at least two times greater than the clearance j of the sealing gasket 300.

In one embodiment, the clearance j of the sealing gasket can be comprised between 0.1 and 1.0 mm, perhaps between 0.5 mm and 1.0 mm.

In one embodiment shown moreover in FIG. 3, the fixed portion 54 of the casing to which the sealing assembly is attached comprises an abutment 502 against which the sealing gasket 300 rests. This embodiment ensures simplified arrangement of the gasket, which can then be positioned precisely on the fixed portion 54 of the casing.

In one embodiment shown moreover in FIG. 3, the straightening member 200 has a radially external attachment flange 202, which is arranged in abutment against a suitable portion of the fixed portion 54 of the casing, for example a radially external flange 501.

This embodiment allows ensuring easy positioning of the air straightening member 200, in that its positioning is then constrained by the radially external attachment flange 202.

In one embodiment, which is that shown in FIG. 3, the sealing gasket 300 can be arranged axially between a spacer 203 of an air straightening member 200 described above, and a radial recess 502 made in the fixed portion 54 of the casing.

In one embodiment, which is that shown in FIG. 3, the sealing assembly can be arranged radially between a fixed portion of a turbomachine casing 54 and an external surface 53 of the rotor mounted in rotation around the axis A. In addition, the air straightening member 200 can comprise a radially external attachment flange 202 which is arranged against an external radial flange 501 of the fixed portion of the turbomachine casing.

This embodiment ensures that the desired distances for the correct operation of the sealing assembly are satisfied by a simplified mechanical assembly, particularly as regards the positioning of the different elements.

In fact, the sealing assembly can then be formed by placing the sealing gasket 300 in abutment against the radial recess 502, then by placing the air straightening member 200 so that the spacer 203 is in abutment against the sealing gasket 300.

Further, the radially external attachment flange 202 of the air straightening member 200 is also in abutment against the radial external flange 501 of the fixed portion 54 of the casing, which ensures redundancy of position control of the air straightening member 200.

In such an embodiment, no measurement of the positioning of an element of the assembly needs to be carried out so that the elements 200, 300 of the sealing assembly are arranged functionally.

Further, it is specified that FIG. 4 is a schematic section in which the straightening member is not shown in full.

In one embodiment, the straightening member comprises a plurality of straightening member sectors, and possibly suitable connecting means between two successive straightening members, so that the set of straightening member sectors allows forming a circumferential straightening member.

This embodiment allows simplifying the assembly and the good durability of the straightening member by decomposing it into a plurality of sectors, each of smaller dimension.

FIG. 5 illustrates the different dimensions of the blades forming, in one embodiment, the straightening member.

In one embodiment, the blades of an air straightening member can have a mean line ζ comprised between 15 mm and 25 mm.

In one embodiment, the thickness e of the blade can be less than or equal to 5.0 mm at all points.

Here the thickness of the blade is understood to be its dimension perpendicular to its height.

Equivalently, the thickness of the blade is defined at a point of the blade 210 as the shortest trajectory allowing passing from the pressure side 210a to the suction side 210b.

In one embodiment, which is not the one shown, the blades 210 of the air straightening member can have a thickness which varies between the leading edge and the trailing edge.

For example, the thickness e of the blade can decrease strictly between the leading edge and the trailing edge of the blade.

In one embodiment, the thickness of the leading edge e₁ and the thickness of the trailing edge e₂ can be such that the thickness at the trailing edge e₂ is comprised between 50% and 100% of the value of the thickness of the leading edge e₁.

Such a variation of the thickness of the blade e allows giving a profile which ensures an increase in the static pressure of the air in the air straightening member 200.

In one embodiment, all the blades 210 of the air straightening member 200 are identical.

In one embodiment, the ratio between the extent L of the blades 210 in the axial dimension and the mean line ζ of the blades is comprised between 0.6 and 0.9.

In one embodiment, the gap between two blades 210 of the air straightening member 200 can be comprised between 9° and 36°.

An angle corresponding to this gap, labeled ε, is described in FIG. 4 which allows better comprehension of it. The gap ε is measured between two blades 210 circumferentially adjacent to one another.

In one embodiment, the angle of attack a of the blades 210 of the air straightening member 200 can be comprised between 30° and 75°.

The orientation, the profile and the dimensions of the blades 210 of the air straightening member 200 ensure elimination of the tangential speed component of the incident air.

Although equal to 0° in the embodiment shown, the exit angle γ is labeled in FIG. 5.

As described above, the exit angle γ is formed between the tangent to the mean line ζ and the axial direction D_{A}.

In FIG. 5, the exit angle is equal to 0° which is optimal for totally eliminating the tangential component of the speed of the incident air flow.

Thus these characteristics allow obtaining excellent servo-control of the sealing gasket 300, even with little difference between the pressures upstream and downstream of the gasket.

The gain in terms of the pressure difference necessary for setting the gasket in motion, compared to sealing gaskets taken in isolation, i.e. without the air straightening member, is at least 20%.

This ensures safer behavior of the sealing gasket, and further avoids the sealing gasket entering into contact with the movable portion in front of which it is arranged.

This performance in terms of safety allows largely compensating the loss caused by the increase of the clearance at equilibrium j of the sealing assembly.

The sealing gasket 300, provided that it has self-adjusting behavior as described above, is not specially limiting in obtaining the technical effect of the invention.

In fact, it is indeed the elimination of the tangential component of the incident air which allows facilitating the return of the sealing gasket 300 to its equilibrium position.

More precisely, the pressure difference between the pressure upstream and downstream of the sealing gasket 300 and that downstream of the sealing gasket 300 no longer needs to be as great as for the sealing gaskets of the prior art, in order for the gasket to be set in motion.

However, a sealing gasket 300 particularly suited to the invention is described hereafter.

In one embodiment, the gasket can be a sealing gasket configured to ensure a predefined clearance between said gasket and an external surface of a rotor mounted in rotation around the axis A arranged facing the gasket, the axis A defining an axial direction, the gasket extending circumferentially around the axis A and comprising a plurality of gasket sectors distributed circumferentially around the axis A, each gasket sector comprising an internal annular sector connected to an external annular sector by a return member, the sealing gasket being characterized in that the internal surface of each internal annular sector comprises at least one row of patterns recessed into the internal surface of the internal annular sectors, each of the patterns having a slender shape extending in an oblique direction relative to the axial direction and being separated from another pattern by a non-recessed portion of the internal surface.

Such an architecture of the gasket 300 differs radically from a labyrinth seal.

However, the internal surface of the internal annular sector indeed ensures aerodynamic sealing while ensuring a predefined clearance with the facing surface.

It is understood that the sealing implemented here is not strict sealing in the sense that the air could not pass through the gasket, but rather relative sealing, the purpose of the sealing gasket being to allow a defined quantity of air to pass.

The “circumferential distribution” of the sealing gasket sectors means that each gasket sector defines a portion of the circumference of the sealing gasket, and that the set of sealing gasket sectors allows obtaining the complete sealing gasket.

In one embodiment, the circumferential distribution is regular, and each sealing gasket sector then represents an equal portion of the circumference of the sealing gasket.

If the clearance of the sealing gasket becomes smaller than the predefined clearance, the pressure radially below the internal surface of the internal annular sectors increases and the internal annular sector then moves so as to increase the clearance, while if the clearance of the sealing gasket becomes greater than the predefined clearance, the return member exerts a greater force than the pressure exerted radially below the internal surface of the internal annular sectors, the latter then returning to their equilibrium positions, i.e. to the predefined clearance.

This aerodynamic equilibrium allows avoiding at all times that the internal surface of the internal annular sector comes into contact with the facing surface and the sealing gasket differs in this from labyrinth seals. Thus the problem of wear that can be encountered in conventional labyrinth seals is dispensed with.

Generally, the patterns present in the thickness of the interiors surface of the internal annular sector allow improving the aerodynamic behavior of the sealing gasket.

The patterns recessed into the internal surface of the internal annular sector further allow modifying the behavior of the sealing gasket, particularly by further increasing the pressure exerted by the air on the internal surface of the internal annular sector when the latter approaches the facing surface.

This makes contact between the internal surface of the internal annular sector and the radially facing surface even more improbable, thus reducing the risk of wear of the gasket.

The patterns are said to be “recessed into the internal surface of the internal annular sector,” because it must be understood that the patterns form a relief in the radial direction of the annular sector, i.e. the direction perpendicular to the axis A, and from the internal surface of the internal annular sector.

The patterns have slender shapes, parallelepipedal for example. It is thus understood that the depth profile of the internal surface of the internal annular sector defining a pattern is identical in the circumferential direction over a given distance, which will be arbitrarily called the width of the pattern.

The second dimension of the pattern, in the plane of the internal surface of the internal annular sector will be arbitrarily called length.

Without departing from the scope of the invention, the width is greater than the length, but for the sake of simplicity only cases in which a pattern is longer than it is wide will be described hereafter.

The dimensions are characterized by width and length for simplicity, but the invention is not reduced to the case where the patterns are rectangular and indeed also relates to slender, and more precisely parallelepipedal patterns.

Thus, and as described, the length of the pattern is in an oblique direction relative to the axial direction.

The inclination quantifying the “oblique” characteristic of the patterns extends as an angle defined between the direction in which the length of a pattern extends and the axial direction.

A sealing gasket compatible with an air straightening member as has been described is now described.

In one embodiment, the sealing gasket can comprise a plurality of gasket sectors distributed circumferentially around the axis A, each gasket sector comprising an internal annular sector connected to an external annular sector by a return member, the sealing gasket being characterized in that the internal surface of each internal annular sector comprises at least one row of patterns recessed into the internal surface of the internal annular sectors, each of the patterns having a slender shape extending in an oblique direction relative to the axial direction and being separated from another pattern by a non-recessed portion of the internal surface.

Such an architecture of the gasket differs radically from a labyrinth seal.

However, the internal surface of the internal annular sector indeed provides aerodynamic sealing while ensuring a predefined clearance with the facing surface.

It is understood that the sealing implemented here is not strict sealing in the sense that air could not pass through the gasket, but rather relative sealing, the purpose of the gasket being to allow a defined quantity of air to pass.

The “circumferential distribution” of the gasket sectors signifies that each gasket sector defines a portion of the circumference of the gasket, and that the set of gasket sectors allows obtaining the complete gasket.

In one embodiment, the circumferential distribution is regular, and each gasket sector then represents an equal portion of the circumference of the sealing gasket.

It is understood that the predefined clearance is a “target” clearance, and that it is possible that the clearance varies slightly about the predefined clearance value under the operating conditions of the gasket. When the gasket is in its equilibrium position, the predefined clearance allows ensuring that the air flow passing through the gasket is the desired air flow. However, if the clearance increases or decreases, the sealing gasket will be brought back to the predefined clearance with respect to spring behavior of the internal annular sectors ensured in particular by the return members.

More precisely, if the clearance of the gasket becomes smaller than the predefined clearance, the pressure radially below the internal surface of the annular sectors increases, and the interior sector then moves so as to increase the clearance, while if the clearance of the gasket becomes greater than the predefined clearance, the return member exerts a force greater than the pressure being exerted radially below the internal surface of the internal annular sectors, the latter then returning to their equilibrium positions, i.e. to the predefined clearance.

This aerodynamic equilibrium allows avoiding at all times that the internal surface of the internal annular sector comes into contact with the facing surface, and the gasket differs in this from labyrinth seals. Thus the wear problem that can be encountered for conventional labyrinth seals is dispensed with.

Generally, the patterns present in the thickness of the internal surface of the internal annular sector allow improving the aerodynamic behavior of the sealing gasket.

In one embodiment, the clearance between the internal surface of the internal annular sector and the radially facing surface can be comprised between 0.1 mm and 1.0 mm perhaps between 0.5 mm and 1.0 mm.

The patterns recessed into the internal surface of the internal annular sector allow modifying the behavior of the gasket, in particular by further increasing the pressure exerted by the air on the internal surface of the internal annular sector when the latter approaches the facing surface.

This makes contact between the internal surface of the internal annular sector and the radially facing surface even more improbable, thus reducing the risk of wear of the gasket.

The patterns are said to be “recessed into the internal surface of the internal annular sector,” because it must be understood that the patterns form a relief in the radial direction, i.e. the direction perpendicular to the axis A, of the annular sector, and from the internal surface of the internal annular sector.

The patterns have slender shapes, parallelepipedal for example. It is thus understood that the depth profile of the internal surface of the internal annular sector defining a pattern is identical in the circumferential direction over a given distance that will be arbitrarily called the width of the pattern.

The second dimension of the pattern, in the plane of the internal surface of the internal annular sector, will be arbitrarily called length.

Without departing from the scope of the invention, the width is greater than the length but, for the sake of simplicity, only cases in which a pattern is longer than it is wide will be described hereafter.

The dimensions are characterized as width and length for simplicity, but the invention is not reduced to the case where the patterns are rectangular, and it relates indeed to slender, and more precisely parallelepipedal patterns.

Thus, and as described, the length of a pattern is in an oblique direction relative to the axial direction.

The inclination quantifying the “oblique” characteristic of the patterns is understood to be the angle defined between the direction in which the length of a pattern extends and the axial direction.

In one embodiment, the patterns have an angle of inclination to the axial direction, this angle of inclination being greater than or equal to 30°.

The angle of inclination of the patterns allows, on the one hand, engraving more patterns or patterns of greater length on the surface of an interior angular sector of given dimensions.

In one embodiment, the angle of inclination of the patterns is comprised between 30° and 60°, perhaps comprised between 30° and 45°.

In fact, that allows further ensuring that the air flow, which possibly has a tangential speed due to the rotation of several elements with which it is possibly in contact, enters into the pattern without having too great a discontinuity.

Preferably, the angle of inclination is oriented in the same direction as the tangential speed of the air flow, or even in the direction of rotation of the facing surface relative to the internal annular sector.

The surface facing the gasket is a surface of a rotor mounted in rotation around the axis A, for example the rotor of a high-pressure turbine of an aeronautical turbomachine. In one embodiment, the patterns can be inclined in the same direction as the direction of rotation of the rotor.

This ensures that the orientation of the patterns is in the direction of the tangential speed of the air passing through said patterns, which improves the general performance of the sealing gasket.

The depth of a pattern is understood to be the distance between the non-recessed internal surface of the internal annular sector and the surface of the pattern, measured perpendicular to the surface of the internal annular sector, i.e. in the radial direction.

In one embodiment, each internal surface of the internal annular sectors comprises a plurality of rows of patterns in the radial direction, each formed from a plurality of patterns in the circumferential direction.

For example, each internal surface of the internal annular sectors comprises a first and a second row of patterns, each of the rows comprising a plurality of patterns distributed in the circumferential direction.

In one embodiment where the gasket comprises two rows of patterns, the patterns of the first row of patterns and the patterns of the second row of patterns have a planar portion on which depth does not vary, and it will be considered that the depth of this planar portion is the depth of the pattern. If the patterns do not have such a planar portion or if they have more than one planar portion, the mean depth of the pattern will be called the depth of the pattern.

The embodiments now described allow ensuring a more rapid return of the sealing gasket to its predefined clearance, and therefor to its equilibrium position.

Further, they ensure that the internal surface of the internal annular sector does not enter into contact with the facing surface in intended or even accidental modes of operation.

In one embodiment where the gasket comprises at least two rows of patterns, the patterns of the first row of patterns have a greater than or equal depth to the patterns of the second row of patterns.

It is understood that the first row of patterns is the first row encountered by the air flow passing through the sealing gasket. In the case where there is only a single row of patterns, the first row is the row of patterns.

If there are two rows of patterns, the first row of patterns can also be characterized as the “upstream row,” and the second row of patterns as the “downstream row.”

In one embodiment, each pattern of the first row of patterns has a downstream planar pattern zone with a constant and non-zero depth and an upstream pattern zone in which the depth varies decreasingly while remaining greater than the constant depth of the downstream pattern zone.

The downstream zone provides the general role of the pattern which is to increase pressure on the internal surface of the internal annular sector when the clearance is less than the predefined clearance.

In one embodiment, the upstream zone of each pattern of the first row of patterns can have a rounded, i.e. convex shape.

In this embodiment, the upstream zone allows ensuring a low pressure loss at the inlet of the sealing gasket. This also allows improving the effectiveness of the gasket overall.

Further, in one embodiment where the gasket comprises at least two rows of patterns, because the patterns are separated by a non-recessed portion of the internal surface of the internal annular sector and that the depth of the downstream portion of the pattern of the first row is non-zero, this embodiment ensures that the air traversing the first pattern encounters a wall directed in the radial direction at the end of the first pattern.

These walls ensure that the force rendered by the air radially below the internal surface of the internal annular sector is directed in the radial direction, independently of its tangential speed, which increases the performance of the sealing gasket.

In one embodiment, the depth of the downstream portion of the first row can be comprised between 1.5 times and 2.5 times the predefined clearance for the sealing gasket.

The inventors have in fact noted that these depth values ensure an excellent distribution of pressures in the gasket, which increases the effectiveness of the gasket.

In one embodiment where the internal surface of each interior sector comprises at least two rows of patterns, each pattern of the second row of patterns has a constant and non-zero downstream planar pattern zone and an upstream pattern zone in which the depth of the pattern varies increasingly from the internal surface of the internal annular sector while remaining less than the constant depth of the upstream pattern zone.

This embodiment allows providing a new compression of the air entering into the pattern, ensuring an additional force below the gasket and therefor better servo-control of the latter in its return to the position of equilibrium.

In one embodiment, each internal surface of the internal annular sectors comprises a first and a second row of patterns, the first row of patterns being offset in the circumferential direction with respect to the second row of patterns.

For example, the patterns of the second row are offset in the circumferential direction with respect to the patterns of the first row by a distance comprised between 0.25 times the width of a pattern and 0.75 times the width of a pattern, perhaps comprised between 0.45 times the width of a pattern and 0.55 times the width of a pattern.

This embodiment allows ensuring that the air flow passing through the gasket and having a tangential speed indeed encounters patterns of the two rows of patterns during its passage in the sealing gasket.

In one embodiment, the internal surface of the internal annular surface can also comprise more than two rows of patterns, for example between two and five rows of patterns.

In one embodiment, the internal surface of each of the first and of the second row of patterns comprises a plurality of patterns distributed in the circumferential direction.

In one embodiment, a row of patterns can comprise more than five patterns, for example between 5 and 20 patterns, preferably between 7 and 15 patterns, perhaps between 9 and 11 patterns.

In one embodiment, the internal surface of the internal annular sector can further comprise, after the last pattern, a non-recessed surface of the internal surface of the internal annular sector, then a portion of increasing depth between the non-recessed surface and the downstream end of the internal annular sector.

Such a profile allows reducing the heterogeneity of pressure at the exit of the sealing gasket, which reduces the risk of vibrational instability of the gasket due to the wake of the air that passes through it.

In one embodiment, the external annular sectors form an external shroud and the internal annular sectors have ends arranged end-to-end in the circumferential direction around the axis A.

In such an embodiment, the circumferential ends of the internal annular sectors can have an angle of inclination with respect to the circumferential direction comprised between 30° and 90°.

This inclination of the circumferential ends of the internal annular sectors of the gasket sectors allows ensuring movement of the internal annular sectors of the gasket sectors with respect to each other.

In fact, during use, the radial movement of the internal annular sectors is not uniform. Inclination of the ends of the internal annular sectors allows reducing the existing clearance between two internal annular sectors, thus improving the effectiveness of the gasket.

In one embodiment, the sealing gasket comprises between 8 and 12 gasket sectors.

For reasons of mechanical durability, bulk and to ensure the planarity of the surface of the sealing gaskets, it would be preferred to have as many sectors as possible. On the other hand, for aerodynamic reasons, it is appropriate to avoid leaks, and therefore to minimize the number of gasket sectors. The inventors have observed that such a number of sectors was an optimal compromise between these two opposite effects.

In one embodiment, the external annular sectors of a sealing gasket can be a single part, for example a shroud. In other words, there is no physical separation between two circumferentially successive external annular sectors.

In one embodiment, such a shroud can be monolithic, i.e. produced in a single part without interconnection. In such a specific case, it will be considered that an angular portion of the shroud can be considered as an external annular sector.

In one embodiment, the sealing gasket further comprises a secondary sealing member arranged radially above the internal annular sector so as to prevent the air from crossing the gasket axially above the annular sector.

Such a secondary sealing member allows ensuring the sealing of the elements of the gasket arranged radially above the internal annular sector. In other words, such a secondary sealing member ensures that the only path allowing the air upstream of the sealing member to cross it passes radially between the internal surface of the internal annular sector and the external surface facing the gasket.

Such a secondary member is known as such by a person skilled in the art, and can for example be selected from a brush gasket, a set of rubbing seals, staking.

The embodiments of the gasket described below are compatible with embodiments of the air straightening member, so that the particular technical effects of certain embodiment can be obtained jointly if that is desired.

1. A sealing assembly for a turbomachine comprising a sealing gasket configured to ensure a predefined clearance between said sealing gasket and an external surface of a rotor mounted in rotation around an axis A, the axis A defining an axial direction, the sealing gasket extending circumferentially around the axis A and the external surface being arranged facing the sealing gasket,
the sealing assembly being characterized in that it further comprises an air straightening member comprising at least one row of blades which extend radially, the air straightening member being located upstream of the sealing gasket, the air straightening member being configured to straighten the air intended to pass through the sealing gasket.

2. The sealing assembly according to claim 1, wherein the air straightening member has fixed blades, the fixed blades having an exit angle less than 10°.

3. The sealing assembly according to claim 2, wherein the blades of the air straightening member have a mean line comprised between 15 mm and 25 mm.

4. The sealing assembly according to claim 2, wherein the gap between two circumferentially adjacent blades is less than 40°.

5. The sealing assembly according to claim 2, wherein the angle of attack of the blades of the air straightening member is comprised between 30° and 75°.

6. The sealing assembly according claim 1, wherein the distance between the inlet of the air straightening member and the upstream edge of the sealing gasket is comprised between 10 mm and 20 mm.

7. The sealing assembly according claim 1, wherein the distance between the exit of the air straightening member and the upstream edge of the sealing gasket is comprised between 2.0 mm and 5.0 mm.

8. The sealing assembly according to claim 1, wherein the air straightening member comprises a spacer integral with the air straightening member.

9. The sealing assembly according to claim 8, wherein the sealing assembly is arranged radially between a fixed portion of a turbomachine casing and the external surface of the rotor mounted in rotation around the axis A, and wherein the sealing gasket is arranged axially between a radial recess of the fixed portion of the turbomachine casing and the spacer of the air straightening member.

10. The sealing assembly according to claim 1, wherein the sealing assembly is arranged radially between a fixed portion of a turbomachine casing and an external surface-of the rotor mounted in rotation around the axis A, and in which the air straightening member comprises an external attachment flange which is mounted against an external radial flange of the fixed portion of the turbomachine casing.

11. An aeronautical turbomachine comprising at least one sealing assembly according to claim 1.

12. The aeronautical turbomachine comprising at least one sealing assembly, wherein the at least one sealing assembly according to claim 1 is arranged on a cooling-air routing circuit, said cooling-air routing circuit comprising an inlet extracting air downstream of the last disk of a high-pressure compressor and an inlet extracting air radially below a combustion chamber which takes the form of an air orifice leading into an air intake cavity in communication with the cooling-air routing circuit, and the sealing assembly being selected from:
an upstream sealing assembly located downstream of the high-pressure compression traversed by the air extracted downstream of the last disk of the high-pressure compressor;
a downstream interior sealing assembly defining the inlet of said air intake cavity and arranged radially below the air inlet orifice;
a downstream exterior sealing assembly defining the exit of said air intake cavity and arranged radially below a high-pressure guide nozzle.
